(19) United States
(12) Patent Application Publication
(10) Pub. No.: US 2026/0232504 A1
(43) Pub. Date: Aug. 13, 2026

(54) ELECTRIC WHEELCHAIR

(71) Applicant: JTEKT CORPORATION, Kariya-shi (JP)

(72) Inventors: Nobuyuki TOGASHI, Nara (JP); Hiroshi KITAMOTO, Aichi (JP); Nobuaki IKEHARA, Nara (JP); Riku NAGAYAMA, Nara (JP); Chishin YOHENA, Nara (JP)

(73) Assignee: JTEKT CORPORATION, Kariya-shi (JP)

(21) Appl. No.: 19/149,637

(22) PCT Filed: Feb. 6, 2023
(86) PCT No.: PCT/JP2023/003825

§ 371 Date: Jul. 21, 2025

(51) Int. Cl. A61G 5/04; A61G 5/10; B60L 15/20

(52) U.S. Cl. CPC A61G 5/041; A61G 5/1037; B60L 15/20; A61G 2203/70; B60L 2200/24; B60L 2250/24

(57) ABSTRACT

An electric wheelchair includes a vehicle body, a drive wheel that causes the vehicle body to travel, a motor that drives the drive wheel, a grip to be held by an operator and displaceable in a front-rear direction of the vehicle body by an operation of the operator, an operation detection unit that detects a position of the grip in the front-rear direction, and a control device that controls the motor based on the position detected by the operation detection unit. The control device changes a control parameter to be used to control the motor in response to occurrence of a predetermined change in an operation state made by the operator or a predetermined change in a slope gradient.

### TECHNICAL FIELD

The present disclosure relates to an electric wheelchair.

### BACKGROUND ART

Patent Documents 1 and 2 below describe electric wheelchairs that are configured to apply a thrust in response to an operation of an operator. In these electric wheelchairs, grips to be held by an operator are provided so as to be movable in a front-rear direction, and a thrust is applied in response to displacement of the grips.

### RELATED ART DOCUMENTS

### Patent Documents

Patent Document 1: Japanese Unexamined Patent Application Publication No. 10-118125 (JP 10-118125 A)
Patent Document 2: Japanese Unexamined Patent Application Publication No. 10-336803 (JP 10-336803 A)

### SUMMARY OF THE INVENTION

### Problem to be Solved by the Invention

In designing of this type of electric wheelchair, it is desirable from a safety standpoint to prevent the occurrence of sudden acceleration or excessive speed when traveling conditions change, for example, during starting off or traveling along a slope. The present invention has been made in view of such issues, and provides an electric wheelchair that is excellent in safety when the operation state of an operator changes or the slope gradient changes.

### Means for Solving the Problem

One aspect of the present invention is an electric wheelchair including: a vehicle body; a drive wheel that causes the vehicle body to travel; a motor that drives the drive wheel; a grip to be held by an operator and displaceable in a front-rear direction of the vehicle body by an operation of the operator; an operation detection unit that detects a position of the grip in the front-rear direction; and a control device that controls the motor based on the position detected by the operation detection unit. The control device changes a control parameter to be used to control the motor in response to occurrence of a predetermined change in an operation state made by the operator or a predetermined change in a slope gradient.

### Effects of the Invention

In the electric wheelchair of the above aspect, the control device is configured to change the control parameter to be used to control the motor in response to the occurrence of the predetermined change in the operation state of the operator or the predetermined change in the slope gradient.

With this configuration, safe movement can be achieved by appropriately changing the control parameter of the motor to suppress the occurrence of, for example, sudden acceleration or excessive speed of the electric wheelchair in response to the predetermined change in the operation state of the operator or the predetermined change in the slope gradient.

As described above, according to the above aspect, it is possible to provide the electric wheelchair that is excellent in safety when the operation state of an operator changes or the slope gradient changes.

Signs in parentheses in the claims indicate corresponding relationships with specific means described in the embodiments described below, and are not intended to limit the technical scope of the present disclosure.

### BRIEF DESCRIPTION OF THE DRAWINGS

The foregoing and other objects, features, and advantages of the present disclosure will become more apparent from the following detailed description when taken in conjunction with the accompanying drawings.

FIG. 1 is a perspective view of an electric wheelchair according to an embodiment.

FIG. 2 is a diagram of a drive unit disposed on a right side of a vehicle body as viewed from the center of the vehicle body in a right-left direction.

FIG. 3 is a sectional view of a first operation unit.

FIG. 4 is a block diagram showing an example of a configuration for controlling the operation of a motor in the electric wheelchair.

FIG. 5 is a diagram for describing a control logic of a control device for a drive mechanism.

FIG. 6 is a diagram schematically showing a state in which an operator operates the electric wheelchair.

FIG. 7 is a flowchart showing a process to be executed by the control device.

FIG. 8 is a diagram for describing a non-holding determination region of a grip.

FIG. 9 is a flowchart showing a non-holding determination process.

FIG. 10 is a diagram schematically showing a state in which a slope gradient transitions from a first reference angle or more to less than a second reference angle that is smaller than the first reference angle.

FIG. 11 is a graph showing a change pattern of a spring constant.

FIG. 12 is a diagram schematically showing a state in which the slope gradient is between the first reference angle and an upper limit reference angle.

FIG. 13 is a diagram schematically showing a state in which the slope gradient transitions from a value between the first reference angle and the upper limit reference angle to the upper limit reference angle or more.

### MODES FOR CARRYING OUT THE INVENTION

Hereinafter, an electric wheelchair that is one embodiment of the above aspect will be described with reference to the drawings.

### Embodiment

### 1. Overall Structure of Electric Wheelchair 1

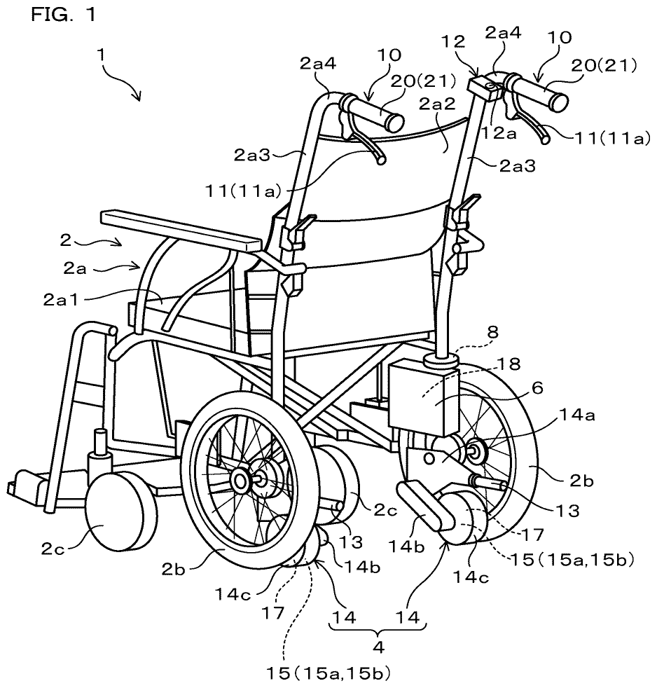

As shown in FIG. 1, an electric wheelchair 1 according to the embodiment is an electric vehicle that travels by an operation of an operator. The traveling of the electric wheelchair 1 is assisted by drive wheels 14c that are electrically driven.

The electric wheelchair 1 includes a wheelchair unit 2, a drive mechanism 4, a control box 6, a first operation unit 10, and a second operation unit 12. The wheelchair unit 2 is a general wheelchair, and includes a vehicle body 2a mainly made of a frame using metal pipes etc., a pair of main wheels 2b, and a pair of casters 2c. The pair of casters 2c is provided on both right and left sides of the vehicle body 2a. The pair of main wheels 2b is also provided on both the right and left sides of the vehicle body 2a. The pair of main wheels 2b is provided behind the pair of casters 2c. Therefore, the pair of main wheels 2b is rear wheels. The pair of casters 2c is front wheels.

The vehicle body 2a includes a seat portion 2al on which an occupant sits, and a backrest portion 2a2. The vehicle body 2a includes a pair of right and left support pipes 2a3. The pair of support pipes 2a3 supports the backrest portion 2a2. A pair of protrusions 2a4 is provided at the upper ends of the pair of support pipes 2a3. The pair of protrusions 2a4 protrudes rearward from the backrest portion 2a2. The pair of protrusions 2a4 is pipes having openings at the rear ends. A pair of first operation units 10 is provided on the pair of protrusions 2a4. Therefore, the pair of first operation units 10 is disposed above the right and left sides of the backrest portion 2a2. The pair of first operation units 10 includes grips 20. The second operation unit 12 is provided on the right protrusion 2a4. The second operation unit 12 includes a plurality of operation switches 12a for receiving operations of the operator. The plurality of operation switches 12a includes an operation switch for turning the power supply on and off, and an operation switch for switching the state of the drive mechanism 4 between a state in which assistance for the movement of the electric wheelchair 1 is started and a state in which the assistance is terminated.

The first operation unit 10 includes a brake lever 11 and a brake sensor 11a for detecting a brake operation and a brake release operation of the brake lever 11. The brake lever 11 is a brake operation unit that is operated by the operator to mechanically brake the vehicle body 2a. When the operator operates the brake lever 11, a braking force is mechanically applied to the drive wheels 14c or the main wheels 2b. The brake sensor 11a is a brake detection unit that detects the brake operation on the brake lever 11 by the operator. The brake operation on the brake lever 11 by the operator is detected by the brake sensor 11a in a brake operation state. The brake release operation on the brake lever 11 by the operator is detected by the brake sensor 11a in a brake operation termination state.

In the following description, a direction in which the occupant faces the front when the occupant rides on the electric wheelchair 1 (direction in which the backrest portion 2a2 faces the front) is defined as a forward direction, and the opposite direction is defined as a rearward direction. Therefore, the occupant rides on the electric wheelchair 1 while facing forward. A direction in which the occupant faces the left side is defined as a leftward direction, and a direction in which the occupant faces the right side is defined as a rightward direction.

The drive mechanism 4 includes a pair of drive units 14. The pair of drive units 14 is fixed to the right and left sides of the vehicle body 2a. The pair of drive units 14 is disposed on the vehicle inner side of the pair of main wheels 2b. Each of the pair of right and left drive units 14 includes a base plate 14a, an arm 14b, the drive wheel 14c, a motor 15, and a tipping bar 13.

### 2. Structure of Drive Unit 14

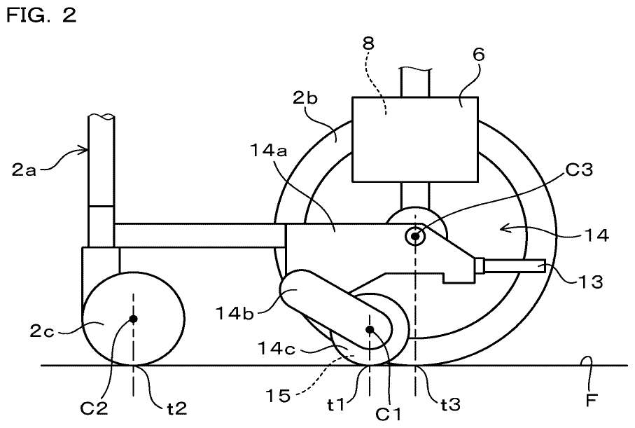

As shown in FIGS. 1 and 2, the base plate 14a is fixed to the frame of the vehicle body 2a. Therefore, the drive unit 14 is attached to the wheelchair unit 2. The tipping bar 13 is provided at the rear end of the base plate 14a. The tipping bar 13 is a member that is stepped on by the leg of the operator who is operating the electric wheelchair 1 from the rear when the operator is climbing over a step. When the operator steps on the tipping bar 13, the casters 2c are lifted upward with the main wheels 2b as pivot points.

The arm 14b is provided on the vehicle inner side of the base plate 14a. The arm 14b is fixed to the base plate 14a so as to be swingable up and down. The arm 14b is swingable within a predetermined angle range. The motor 15 and the drive wheel 14c are provided at the tip of the arm 14b. The arm 14b rotatably supports the drive wheel 14c. The arm 14b elastically urges the drive wheel 14c downward. Therefore, the arm 14b presses the drive wheel 14c against a road surface to bring it into contact with the road surface.

The motor 15 is an in-wheel motor and is provided inside the drive wheel 14c. A rotor (not shown) of the motor 15 can rotate together with the drive wheel 14c. A stator (not shown) of the motor 15 is fixed to the arm 14b side. Thus, the motor 15 drives the drive wheel 14c to rotate. The motor 15 is connected to a battery, a control device, etc. in the control box 6 via a cable (not shown). The cable is inserted through the arm 14b and connects the motor 15 and the control box 6. The control box 6 is fixed to a frame portion on the lower right side of the seat portion 2al. The control box 6 houses the battery, the control device for controlling each part, etc.

The drive wheel 14c is supported by the arm 14b so as to be rotatable about a rotation axis C1 (see FIG. 2) that is parallel to the right-left direction. The drive wheel 14c is driven to rotate by the motor 15 while being in contact with the road surface. The pair of right and left motors 15 drives the pair of right and left drive wheels 14c, thereby causing the wheelchair unit 2 (vehicle body 2a) to travel.

As shown in FIG. 2, the drive wheel 14c is disposed between the caster 2c and the main wheel 2b. More specifically, the position of the rotation axis C1 in the front-rear direction is between a rotation axis C2 of the caster 2c and a rotation axis C3 of the main wheel 2b. Therefore, a ground contact position t1 of the drive wheel 14c on a road surface F is located between a ground contact position t2 of the caster 2c and a ground contact position t3 of the main wheel 2b. The ground contact position t1 of the drive wheel 14c may be located in the range from the ground contact position t2 to the ground contact position t3. In other words, the position of the rotation axis C1 in the front-rear direction may be located in the range from the position of the rotation axis C2 to the position of the rotation axis C3.

### 3. Structure of First Operation Unit 10

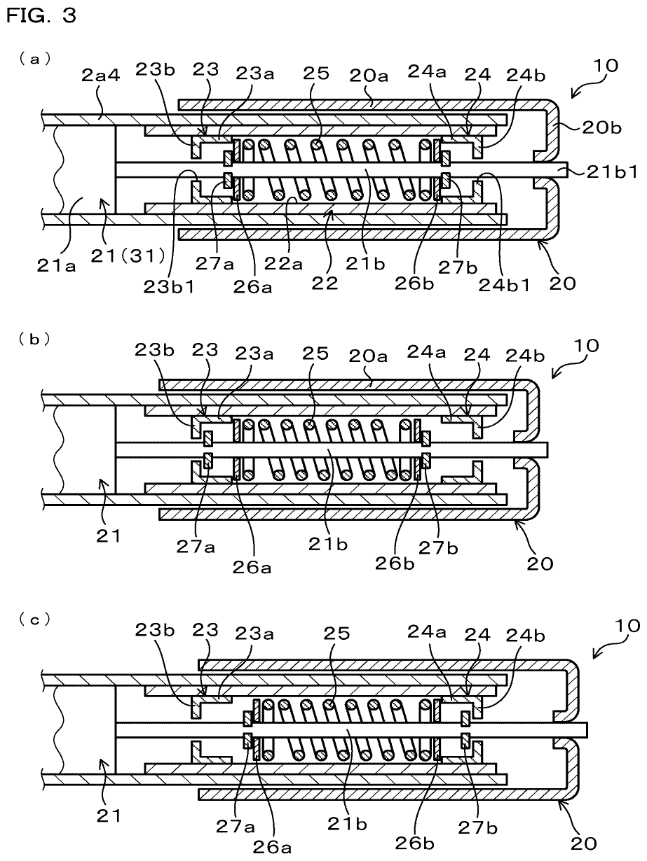

As shown in part (a) in FIG. 3, the first operation unit 10 includes an operation detection unit 21 in addition to the grip 20. The grip 20 is attached to the tip of the protrusion 2a4 on the vehicle left side. The grip 20 includes a tubular portion 20a and a bottom portion 20b. The bottom portion 20b closes the opening on the rear side of the tubular portion 20a. The tubular portion 20a is attached to the outer circumferential side of the protrusion 2a4. The tubular portion 20a is movable while sliding on the outer circumferential surface of the protrusion 2a4. Therefore, the grip 20 is movable along an axial direction of the protrusion 2a4. The protrusion 2a4 extends along the front-rear direction. Therefore, the grip 20 can be held by the operator and can be displaced in the front-rear direction relative to the vehicle body 2a by the operation of the operator.

The operation detection unit 21 has a function of detecting the position and the displacement amount of the grip 20 in the front-rear direction as displacement information of the grip 20 in the front-rear direction. The operation detection unit 21 also has a function of detecting information about the grip 20 being held by the operator from the displacement information of the grip 20 in the front-rear direction. Therefore, the operation detection unit 21 is a state sensor that detects the operating state or the holding state of the operator for the grip 20.

In the present embodiment, the operation detection unit 21 is a potentiometer. The operation detection unit 21 is provided inside the protrusion 2a4. The operation detection unit 21 includes a body 21a and a rod 21b. The body 21a is fixed to the protrusion 2a4. The rod 21b extends rearward from the body 21a. The rod 21b passes through the tubular portion 20a and the protrusion 2a4. The rod 21b is movable in the axial direction relative to the body 21a. The operation detection unit 21 detects and outputs the displacement amount of the rod 21b in the axial direction. A tip 21b1 of the rod 21b is fixed to the bottom portion 20b. Therefore, the rod 21b moves together with the grip 20 in the front-rear direction. Thus, the operation detection unit 21 can detect the displacement amount of the grip 20 in the front-rear direction relative to the vehicle body 2a. The operation detection unit 21 is connected to the control device described later inside the control box 6. The output of the operation detection unit 21 is provided to the control device.

In addition to the above operation detection unit 21, a sleeve 22, a front bush 23, a rear bush 24, and a spring 25 are provided inside the protrusion 2a4. The sleeve 22 is a cylindrical member that is inserted into and fixed to the inner circumferential surface of the protrusion 2a4. The front bush 23, the rear bush 24, and the spring 25 are disposed on the inner circumferential side of the sleeve 22.

The front bush 23 includes a cylindrical portion 23a and a bottom portion 23b. The cylindrical portion 23a is inserted into and fixed to an inner circumferential surface 22a of the sleeve 22. The bottom portion 23b is provided at the front opening of the cylindrical portion 23a. The bottom portion 23b has a central hole 23b1. The rod 21b is inserted through the central hole 23b1. The rear bush 24 includes a cylindrical portion 24a and a bottom portion 24b. The cylindrical portion 24a is inserted into and fixed to the inner circumferential surface 22a of the sleeve 22. The bottom portion 24b is provided at the rear opening of the cylindrical portion 24a. The bottom portion 24b has a central hole 24b1. The rod 21b is inserted through the central hole 24b1.

The spring 25 is disposed between the front bush 23 and the rear bush 24. Therefore, the rod 21b passes through the front bush 23, the rear bush 24, and the spring 25. The rod 21b has a front retainer 26a, a front snap ring 27a, a rear retainer 26b, and a rear snap ring 27b. The front snap ring 27a is provided forward of the spring 25. The front snap ring 27a is fixed to the rod 21b. The front snap ring 27a is fitted to a circumferential groove provided in the rod 21b. Therefore, the front snap ring 27a can move together with the rod 21b in the axial direction. The rear snap ring 27b is provided rearward of the spring 25. The rear snap ring 27b is also fixed to the rod 21b. The rear snap ring 27b is fitted to a circumferential groove provided in the rod 21b. Therefore, the rear snap ring 27b can move together with the rod 21b in the axial direction. That is, the front snap ring 27a and the rear snap ring 27b are fixed to the rod 21b at a constant distance in the axial direction.

The front retainer 26a, the rear retainer 26b, and the spring 25 are disposed between the front snap ring 27a and the rear snap ring 27b. The front retainer 26a and the rear retainer 26b are annular members through which the rod 21b passes. The front retainer 26a and the rear retainer 26b hold the front end face and the rear end face of the spring 25. The front retainer 26a is interposed between the front bush 23 and the front end face of the spring 25. The rear retainer 26b is interposed between the rear bush 24 and the rear end face of the spring 25.

### 4. Neutral Position of Grip 20

Part (a) in FIG. 3 shows the grip 20 in a neutral position. The grip 20 is in the neutral position when it is not being held by the operator or when the operator is not inputting an operation force. When the grip 20 is in the neutral position, the spring 25 urges the front retainer 26a toward the front bush 23. The spring 25 also urges the rear retainer 26b toward the rear bush 24. At this time, the front retainer 26a is in contact with the cylindrical portion 23a of the front bush 23. The rear retainer 26b is in contact with the cylindrical portion 24a of the rear bush 24. That is, when the grip 20 is in the neutral position, the distance between the front retainer 26a and the rear retainer 26b is smaller than the free length of the spring 25.

### 5. Front Position of Grip 20

Part (b) in FIG. 3 shows the grip 20 that has moved to a front position forward of the neutral position. When the grip 20 moves forward from the neutral position, the rod 21b also moves forward. Therefore, the output of the operation detection unit 21 changes. When the grip 20 and the rod 21b move forward from the neutral position, the spring 25 is pressed forward by the rear retainer 26b and the rear snap ring 27b. Thus, the rear retainer 26b moves away from the rear bush 24. When the grip 20 moves further forward, the front snap ring 27a comes into contact with the bottom portion 23b of the front bush 23 as shown in part (b) in FIG. 3. Thus, the front snap ring 27a and the front bush 23 limit the forward movement of the rod 21b.

### 6. Rear Position of Grip 20

Part (c) in FIG. 3 shows the grip 20 that has moved to a rear position rearward of the neutral position. When the grip 20 moves rearward from the neutral position, the rod 21b also moves rearward. Therefore, the output of the operation detection unit 21 changes. When the grip 20 and the rod 21b move rearward from the neutral position, the spring 25 is pressed rearward by the front retainer 26a and the front snap ring 27a. Thus, the front retainer 26a moves away from the front bush 23. When the grip 20 moves further rearward, the rear snap ring 27b comes into contact with the bottom portion 24b of the rear bush 24 as shown in part (c) in FIG. 3. Thus, the rear snap ring 27b and the rear bush 24 limit the rearward movement of the rod 21b.

With the above configuration, the grip 20 is elastically movable in the front-rear direction by the spring 25 with the neutral position at the center. The range of movement of the grip 20 and the rod 21b in the front-rear direction is limited by the front bush 23, the rear bush 24, the front snap ring 27a, and the rear snap ring 27b.

### 7. Configuration of Electric Wheelchair 1

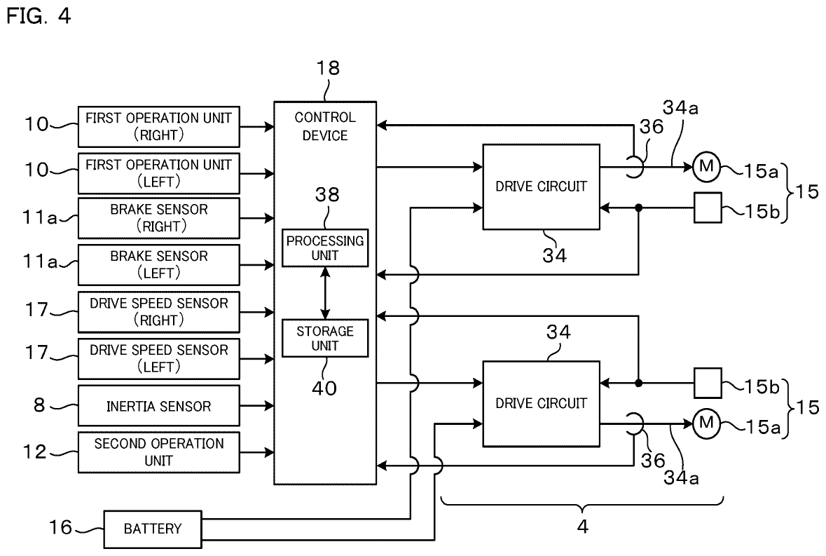

As shown in FIG. 4, the electric wheelchair 1 further includes right and left drive speed sensors 17, an inertia sensor 8, a battery 16, and a control device 18. All of the inertia sensor 8, the battery 16, and the control device 18 are housed in the control box 6 (see FIG. 1).

The drive speed sensor 17 detects the drive speed of the drive wheel 14c. The drive speed sensor 17 is attached to the drive wheel 14c. The drive speed sensor 17 is electrically connected to the control device 18. Therefore, the output of the drive speed sensor 17 is provided to the control device 18. The traveling speed of the vehicle body 2a of the electric wheelchair 1 can be calculated from the drive speed of the drive wheel 14c. Therefore, the drive speed sensor 17 can be regarded as a traveling speed detection unit that detects the traveling speed of the vehicle body 2a of the electric wheelchair 1.

The inertia sensor 8 detects information on inertia acting on the vehicle body 2a. In the present embodiment, the inertia sensor 8 is, for example, an IMU (Inertial Measurement Unit), and includes at least a three-axis acceleration sensor. The inertia sensor 8 is electrically connected to the control device 18. Therefore, the output of the inertia sensor 8 is provided to the control device 18. The control device 18 determines the inclination angle of the vehicle body 2a in the front-rear direction based on the output of the inertia sensor 8. That is, the inertia sensor 8 functions as a sensor for detecting the inclination angle of the vehicle body 2a in the front-rear direction. When the road surface is a slope, the inertia sensor 8 can detect the inclination angle of the vehicle body 2a as a slope gradient.

The battery 16 supplies electric power to the pair of motors 15 and each part that requires operating power. The control device 18 has a function of controlling the drive mechanism 4 (pair of motors 15) by giving a command value to the drive mechanism 4, thereby controlling the speed of the vehicle body 2a.

The drive mechanism 4 including the pair of motors 15 includes a pair of drive circuits 34. Each of the pair of motors 15 includes a motor body 15a and a rotation detector 15b. The motor body 15a includes main components of a motor, such as a rotor and a stator. The rotation detector 15b is, for example, a Hall sensor provided on the motor body 15a. The rotation detector 15b detects the rotation angle of the rotor of the motor body 15a. The rotation detector 15b is connected to the drive circuit 34 and the control device 18. Therefore, the output of the rotation detector 15b is provided to the drive circuit 34 and the control device 18. At this time, the rotation speed of the motor 15 is derived from the rotation angle of the rotor of the motor body 15a. Therefore, the rotation detector 15b functions as a motor information detection unit that detects motor information on the rotation speed of the motor 15. The motor information detected by the rotation detector 15b is also information on the rotation of the drive wheel 14c. Therefore, the rotation detector 15b can also be regarded as a rotation information detection unit that detects information on the rotation of the drive wheel 14c.

The pair of drive circuits 34 is, for example, inverters. The pair of drive circuits 34 may be housed in the control box 6, or may be provided on the base plates 14a or the arms 14b. The pair of drive circuits 34 is connected to the control device 18, the battery 16, and the pair of motors 15. The pair of drive circuits 34 supplies electric power in the battery 16 to the pair of motors 15. The pair of drive circuits 34 has a function of supplying drive power to the pair of motors 15 based on speed command values provided from the control device 18 and the outputs of the rotation detectors 15b, and controlling the motors 15 such that they reach the rotation speeds indicated by the speed command values.

The pair of drive circuits 34 and the pair of motors 15 (motor bodies 15a) are connected by a pair of power lines 34a. A pair of current detection units 36 is provided on the pair of power lines 34a. The pair of current detection units 36 is current sensors that detect currents flowing through the pair of power lines 34a. That is, the pair of current detection units 36 detects motor currents flowing through the pair of motors 15. The pair of current detection units 36 is connected to the control device 18. Therefore, the outputs of the pair of current detection units 36 are provided to the control device 18.

The pair of first operation units 10 and the second operation unit 12 are also connected to the control device 18. As described above, the outputs of the first operation units 10 (i.e., the outputs of the operation detection units 21) and the output of the second operation unit 12 are provided to the control device 18. In the present embodiment, the outputs of the pair of operation detection units 21 are defined as operation inputs of the pair of grips 20 to the control device 18.

The control device 18 is a computer etc. including a processing unit 38 that is a processor etc. and a storage unit 40 that is a memory, a hard disk, etc. The storage unit 40 stores a computer program to be executed by the processing unit 38 and necessary information. The processing unit 38 implements various processing functions of the control device 18 by executing a computer program stored in a non-transitory computer-readable storage medium such as the storage unit 40.

### 8. Configuration of Control Device 18

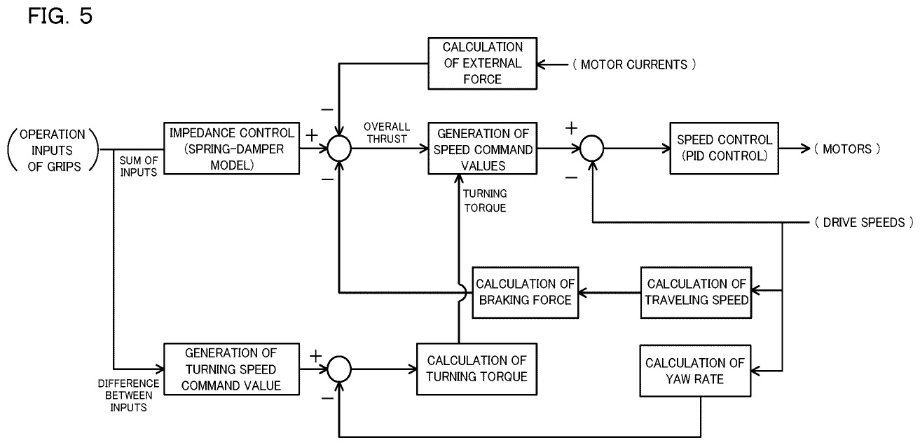

The control device 18 controls the drive mechanism 4 in accordance with a control logic shown in FIG. 5.

Based on the operation inputs (displacement amounts) of the pair of grips 20, impedance control and generation of a turning speed command value are executed. The impedance control uses a spring-damper model described later. Through the impedance control, a basic thrust is calculated based on the sum of the operation inputs of the pair of grips 20 (sum of displacement amounts). The turning speed command value is generated based on the difference between the operation inputs of the pair of grips 20 (difference between displacement amounts). An overall thrust is calculated by subtracting an external force and a braking force from the basic thrust. The external force is a force that the vehicle body 2a receives from the outside, and is calculated based on the motor currents detected by the current detection units 36 (see FIG. 4). The braking force is calculated using the traveling speed. The traveling speed is calculated from the drive speeds detected by the drive speed sensors 17 (see FIG. 4).

Speed command values for the motors 15 are generated based on the overall thrust and a turning speed torque. The speed command value for each of the pair of motors 15 for turning the vehicle body 2a is generated based on the turning speed torque. The turning torque is calculated based on a value obtained by subtracting a yaw rate from the turning speed command value. The yaw rate is a turning speed, and is calculated based on the drive speeds of the drive wheels 14c and a wheel distance between the pair of drive wheels 14c. That is, the yaw rate is calculated by dividing the difference between the drive speeds of the pair of drive wheels 14c by the wheel distance. In the calculation process for the turning torque, it is preferable to use proportional control (P control) for performing adjustment proportional to a deviation between a current output value and a target value. This can simplify the calculation process for the turning torque. In the present embodiment, the external force used when calculating the overall thrust is not used when calculating the turning torque. When the external force is not used in the calculation of the turning torque, the turning control is less susceptible to external influences.

Then, the speed control on the motors 15 is executed based on the generated speed command values and the drive speeds of the drive wheels 14c. That is, the speed command values are generated for the pair of drive wheels 14c, and the two generated speed command values are applied to the pair of motors 15. In this speed control, for example, known PID control can be used to improve responsiveness. The PID control is addition of integral operation feedback control (I control) and differential operation feedback control (D control) to the above P control.

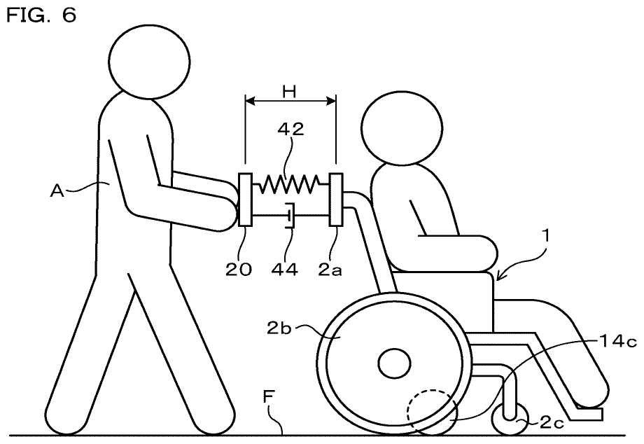

As shown in FIG. 6, when an operator A wants to move the electric wheelchair 1 along the road surface F, the operator A of the electric wheelchair 1 operates the grips 20 of the pair of first operation units 10 while holding them with the right and left hands. At this time, the pair of grips 20 moves in the front-rear direction relative to the vehicle body 2a. The pair of first operation units 10 provides outputs corresponding to the movements of the pair of grips 20 to the control device 18. The control device 18 generates speed command values for the motors 15 based on the outputs provided from the pair of first operation units 10, and provides the speed command values to the pair of drive circuits 34. In this manner, the control device 18 controls the motors 15.

When the operator A holds the grips 20 and operates them to push forward, the motors 15 are controlled such that the drive wheels 14c assist forward movement of the electric wheelchair 1. When the operator A holds the grips 20 and operates them to pull rearward, the motors 15 are controlled such that the drive wheels 14c assist rearward movement of the electric wheelchair 1. When the operator A is in a non-holding state in which he or she is not holding the grips 20 or when the operator A does not operate the grips 20 in the front-rear direction from the neutral positions, the motors 15 are controlled so as not to drive the drive wheels 14c. As described above, the control device 18 determines whether the operator A is in an operating state or a non-operating state relative to the grips 20 or whether the operator A is in the holding state or the non-holding state relative to the grips 20, and controls the motors 15 depending on the operating state or the non-operating state or depending on the holding state or the non-holding state.

The outputs from the pair of first operation units 10 indicate the displacement amounts of the pair of grips 20 in the front-rear direction relative to the vehicle body 2a. The control device 18 determines the displacement amounts of the pair of grips 20 in the front-rear direction based on the outputs of the pair of first operation units 10. The displacement amount is a distance between a reference position (e.g., the neutral position) that is preset within the movable range of the grip 20 and a current position of the grip 20. When the reference position and the current position agree with each other in the front-rear direction, the displacement amount is 0 (zero). The control device 18 discretely acquires the displacement amounts of the grips 20 over time and stores them in the storage unit 40.

When the operator A holds and operates the first operation units 10 and the second operation unit 12, the control device 18 controls the drive mechanism 4 such that the motion of the vehicle body 2a in response to the displacement amounts simulates mechanical impedance characteristics. That is, as shown in FIG. 6, the control device 18 controls the drive mechanism 4 to maintain a constant distance H between the grip 20 and the vehicle body 2a while reproducing a motion in which the grip 20 and the vehicle body 2a are connected by a virtual spring 42 and a virtual damper 44. In the present embodiment, a spring-damper model using the virtual spring 42 and the virtual damper 44 is used for the impedance control (see FIG. 5).

The control on the drive mechanism 4 to maintain the constant distance H between the grip 20 and the vehicle body 2a includes control to maintain the displacement amount at 0 (zero) or at a predetermined set value. Therefore, the control device 18 controls the drive mechanism 4 to move the vehicle body 2a according to the displacement amount of the grip 20. For example, when the operator A moves forward and presses the grip 20 forward, the control device 18 controls the drive mechanism 4 to move the vehicle body 2a forward. Conversely, when the operator A moves rearward and pulls the grip 20 rearward, the control device 18 controls the drive mechanism 4 to move the vehicle body 2a rearward. When the grip 20 is in the reference position (neutral position), the control device 18 controls the drive mechanism 4 to stop the vehicle body 2a.

The above spring-damper model is represented as the following expression (1). The processing unit 38 of the control device 18 determines a target thrust Fₜₕ of the motor 15 (hereinafter simply referred to as “thrust”) based on the following expression (1).

$$\begin{matrix}[ Math . 1 ] & \\ {F}_{th} = ( K + \frac{{ω}_{1}}{s + {ω}_{1}} sD ) ( {x}_{UI \_ R} + {x}_{UI \_ L} ) - μ v - \frac{{ω}_{2}}{s + {ω}_{2}} sMv - α {F}_{op} & ( 1 )\end{matrix}$$

The expression (1) represents the thrust Fin subjected to Laplace transform. In the expression (1), K is a virtual spring constant, D is a virtual damper coefficient, u is a friction coefficient, M is a virtual mass of the electric wheelchair 1, v is a traveling speed of the electric wheelchair 1, a is a coefficient, s is a Laplace operator, ω1 and ω2 are predetermined cut-off frequencies, a displacement amount X_{UI_R} and a displacement amount X_{UI_L} are displacement amounts of the grips 20, and Fₒₚ is an external force in the front-rear direction.

The following first term in the expression (1) represents a model for achieving the mechanical impedance characteristics.

$$First term : ( K + \frac{{ω}_{1}}{s + {ω}_{1}} sD ) ( {x}_{UI \_ R} + {x}_{UI \_ L} ) \qquad [ Math . 2 ]$$

The spring constant K in the first term is multiplied by the total displacement amount of the displacement amount X_{UI_R} of the right grip 20 and the displacement amount X_{UI_L} of the left grip 20. The product of the spring constant K and the total displacement amount represents an elasticity term based on the displacement amount. This elasticity term is based on the displacement amounts X_{UI_R}, X_{UI_L} of the grips 20. The spring constant K is a spring constant of the virtual spring 42 (FIG. 6) and is a preset constant. The damper coefficient D in the first term is multiplied by the Laplace operator and the total displacement amount. The product of the total displacement amount and the Laplace operator represents a differential value of the displacement amount. Therefore, the product of the damper coefficient D, the Laplace operator, and the total displacement amount represents a viscosity term based on the differential value of the displacement amount. This viscosity term is based on the displacement speeds of the grips 20. The damper coefficient D is a coefficient indicating the viscosity of the virtual damper 44 (see FIG. 6) and is a preset constant. Thus, the first term includes the elasticity term based on the displacement amount and the viscosity term based on the differential value of the displacement amount.

The following second term in the expression (1) represents a deceleration force in the front-rear direction of the vehicle body 2a.

$$Second term : - μ v - \frac{{ω}_{2}}{s + {ω}_{2}} sMv \qquad [ Math . 3 ]$$

In the second term, a friction force according to the traveling speed v and a deceleration force according to the acceleration are determined. The sum of these forces is the deceleration force in the front-rear direction of the vehicle body 2a. The deceleration force in the front-rear direction of the vehicle body 2a determined in the second term is added to the calculation result of the first term.

The following third term in the expression (1) is a term for correcting the movement in the front-rear direction.

Third term: −αFₒₚ

The coefficient α in the third term is a variable that changes depending on the total displacement amount, and is a coefficient to be used to calculate the external force Fₒₚ. Hereinafter, the coefficient α will be referred to as “feedback coefficient α.” The external force Fₒₚ is derived by integrating the motor current values of the motors 15 and torque coefficients (torques generated by the motors per unit current). αFₒₚ is a value that changes depending on the external force in the front-rear direction and the total displacement amount, and is appropriately adjusted according to the external force in the front-rear direction and the total displacement amount. An upper limit value and a lower limit value are set for αFₒₚ. Thus, it is possible to suppress deceleration or acceleration more than necessary.

### 9. Process of Control Device 18

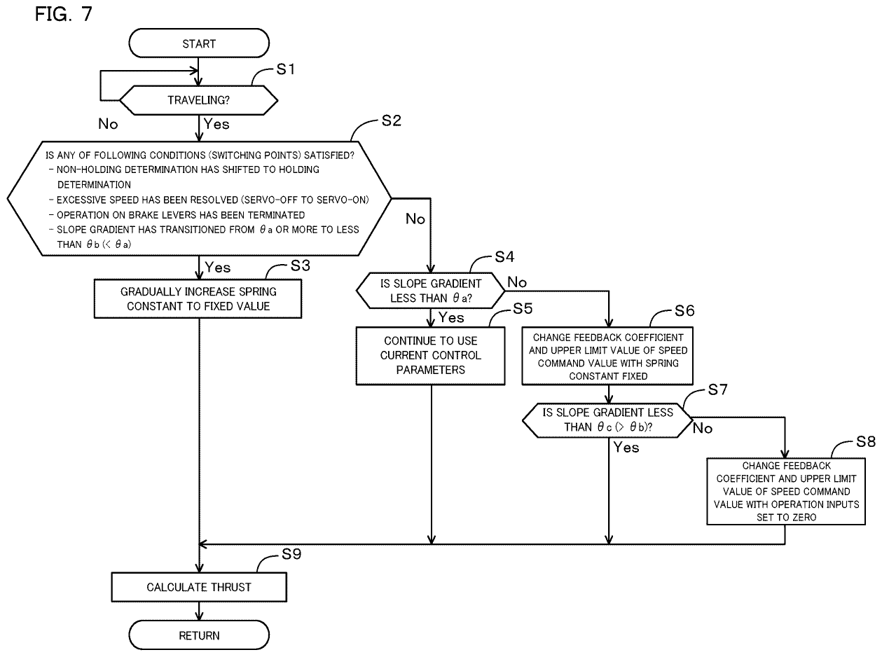

As shown in FIG. 7, the processing unit 38 of the control device 18 executes a process sequentially from step S1 to step S9 to control the drive mechanism 4.

The grip 20 in the holding state or the non-holding state is substantially the same as the grip 20 in the operating state or the non-operating state. That is, the operator operates the grip 20 while holding the grip 20, and terminates the holding of the grip 20 when terminating the operation on the grip 20. Therefore, in this specification, “non-holding determination” and “holding determination” will be referred to also as “non-operating determination” and “operating determination,” respectively, and the “non-holding state” and the “holding state” will be referred to also as the “non-operating state” and the “operating state,” respectively.

Step S1 in FIG. 7 is a step of determining whether the electric wheelchair 1 is traveling based on information detected by the drive speed sensors 17 (see FIG. 4). When the electric wheelchair 1 is traveling (“Yes” in step S1), the grips 20 are in the holding state or the operating state for the operator, and the brake levers 11 are in the brake operation termination state for the operator. Then, the process proceeds to step S2.

### 10. Non-Holding Determination Process

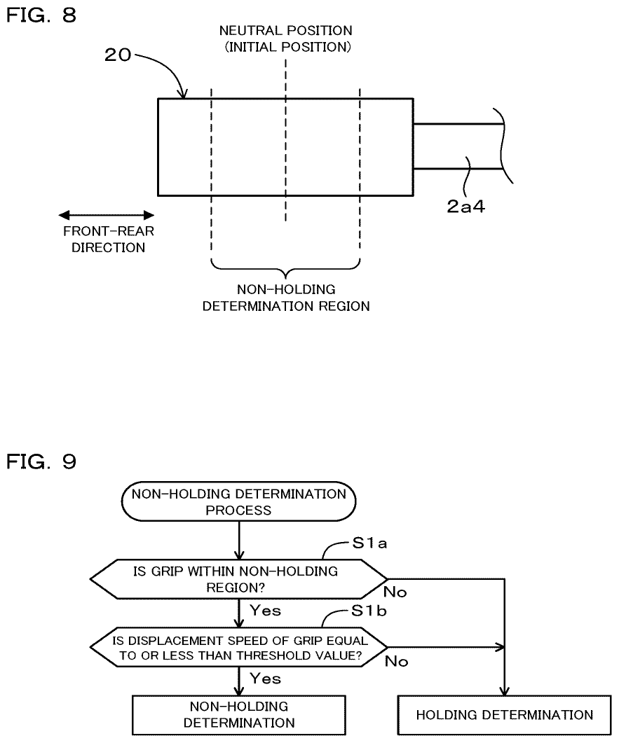

A non-holding determination process for the grips 20 is a non-operating determination process for the grips 20. In the present embodiment, a non-holding determination region is set for the grip 20 in the non-holding determination process as shown in FIG. 8. The non-holding determination region includes the neutral position (see part (a) in FIG. 3) that is the initial position of the grip 20. The non-holding determination region is a non-operating determination region.

As shown in FIG. 9, the non-holding determination process includes steps S1a and S1b.

Step S1a is a step of determining whether each grip 20 is within the non-holding determination region. When the grip 20 is within the non-holding determination region (“Yes” in step S1a), the process proceeds to step S1b. When the grip 20 is not within the non-holding determination region (“No” in step S1a), the “holding determination” is made that the grip 20 is in the holding state. This holding determination is also the “operating determination” that the grip 20 is in the operating state.

Step S1b is a step of determining whether the displacement speed of each grip 20 is equal to or less than a threshold value. When the displacement speed of the grip 20 is equal to or less than the threshold value (“Yes” in step S1b), the “non-holding determination” is made that the grip 20 is in the non-holding state. This non-holding determination is also the “non-operating determination” that the grip 20 is in the non-operating state. When the displacement speed of the grip 20 exceeds the threshold value (“No” in step S1b), the “holding determination” is made that the grip 20 is in the holding state. The threshold value used in step S1b is stored in advance in the storage unit 40.

Step S2 in FIG. 7 is a step of determining whether any of the following four conditions is satisfied. When any of the four conditions is satisfied (“Yes” in step S2), the process proceeds to step S3. Otherwise (“No” in step S2), the process proceeds to step S4. The four conditions are conditions related to switching points of control parameters to be used to control the motors 15.

The first condition in step S2 is that the determination on the grips 20 has shifted from the non-holding determination to the holding determination. The control device 18 determines that the first condition is satisfied when determination is made, based on the non-holding determination process, that the operation state of the grips 20 for the operator is switched from the non-holding state or the non-operating state to the holding state or the operating state.

The second condition in step S2 is that the excessive speed of the vehicle body 2a (electric wheelchair 1) has been resolved. The control device 18 determines that the second condition is satisfied when detection is made, based on information from the drive speed sensors 17 (see FIG. 4), that the speed of the vehicle body 2a exceeding the speed limit is changed to a speed equal to or less than the speed limit, or when detection is made that the state of the motors 15 is switched from a servo-off state to a servo-on state. When the motors 15 are in the servo-on state, the movement of the electric wheelchair 1 is assisted by the drive wheels 14c. When the motors 15 are in the servo-off state, the assistance for the movement of the electric wheelchair 1 by the drive wheels 14c is terminated.

The third condition in step S2 is that the operation on the brake levers 11 by the operator is terminated. The control device 18 determines that the third condition is satisfied when detection is made, based on information from the brake sensors 11a (see FIG. 4), that the operation state of the brake levers 11 is switched from the brake operation state to the brake operation termination state.

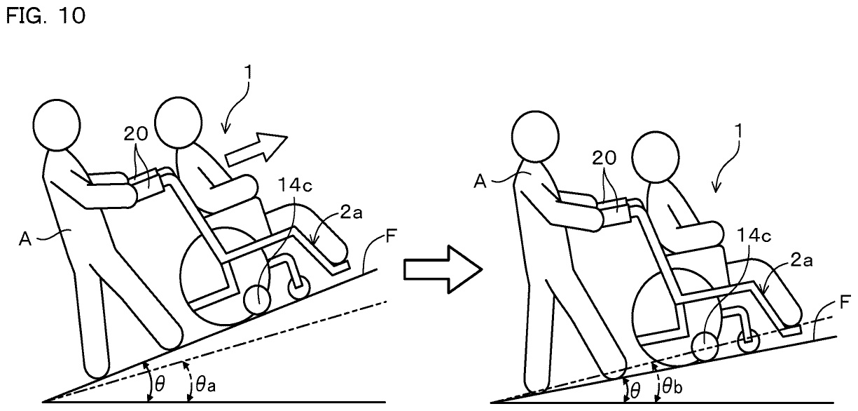

The fourth condition in step S2 is that a slope gradient θ of a road surface has transitioned from a first reference angle θa or more to less than a second reference angle θb that is smaller than the first reference angle θa (see FIG. 10). The control device 18 determines that the fourth condition is satisfied when detection is made, based on information from the inertia sensor 8 (see FIG. 4), that the slope gradient θ is switched from the first reference angle θa or more to less than the second reference angle θb.

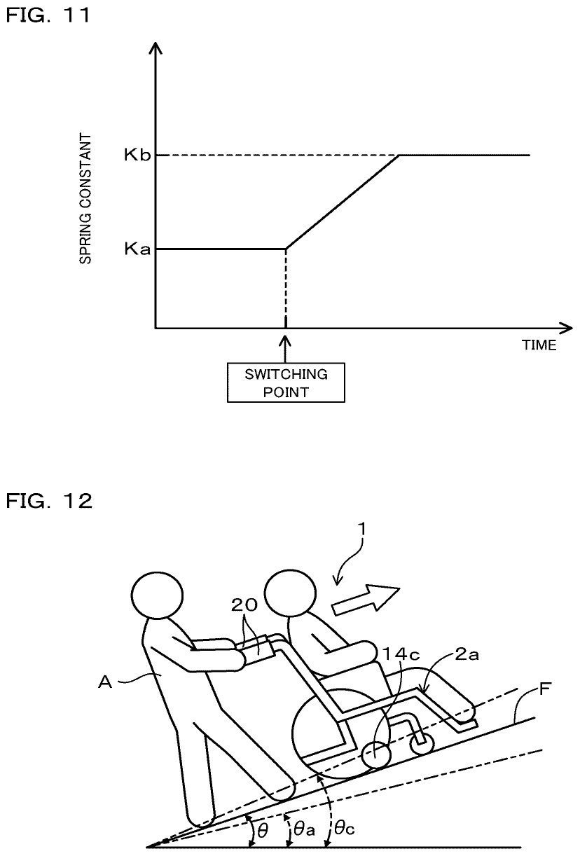

Step S3 is a step of gradually increasing (making larger) the spring constant K (see the expression (1)) constituting the elasticity term of the above spring-damper model. As in a change pattern of the spring constant shown in FIG. 11, the spring constant K is gradually increased from a first value Ka to a second value Kb under the condition that the control parameter switching point is detected. The spring constant K is one of the control parameters to be used to control the motors 15. Step S3 is followed by step S9 in which the thrust to be generated by the motors 15 is calculated. Based on steps S3 and S9, the motors 15 are controlled such that the thrust generated by the motors 15 gradually increases. Thus, the generated acceleration changes to gradually increase. As a result, sudden acceleration in which the acceleration acting on the vehicle body 2a increases suddenly can be suppressed and safe movement can be achieved.

Step S4 is a step of determining, based on the information from the inertia sensor 8, whether the slope gradient θ of the road surface is less than the first reference angle θa. When the slope gradient θ is less than the first reference angle θa (“Yes” in step S4), the process proceeds to step S5. When the slope gradient θ is equal to or more than the first reference angle θa (“No” in step S4), the process proceeds to step S6.

For example, the process proceeds from step S4 to step S5 when the slope gradient θ transitions from the second reference angle θb to a value between the second reference angle θb and the first reference angle θa, or when the slope gradient θ transitions from the first reference angle θa to a value between the second reference angle θb and the first reference angle θa. For example, the process proceeds from step S4 to step S6 when the slope gradient θ transitions from the second reference angle θb to the first reference angle θa or more.

Step S5 is a step of setting the current control parameters used to control the motors 15 such that the use of them is continued. After step S5 is executed, the process proceeds to step S9. Based on steps S5 and S9, the motors 15 are controlled without any change in the control logic.

Step S6 is a step of changing, while maintaining the spring constant K at a fixed value, both the feedback coefficient α constituting the third term of the above spring-damper model and the upper limit value of the speed command value for each of the motors 15. Each of the feedback coefficient α and the upper limit value of the speed command value is one of the control parameters to be used to control the motors 15. In step S6 of the present embodiment, the feedback coefficient α is made larger and the upper limit value of the speed command value for each of the motors 15 is made smaller than those in the case where the slope gradient θ is less than the first reference angle θa. After step S6 is executed, the process proceeds to step S7.

In the case based on step S6, the thrust generated by the motors 15 decreases by controlling the motors 15 with the feedback coefficient α changed to a large value. By controlling the motors 15 with the upper limit value of the speed command value for each of the motors 15 changed to a small value, the motors 15 are prevented from being driven such that the rotation speeds of the motors 15 exceed the changed upper limit value. Therefore, when the slope gradient θ transitions to increase up to the first reference angle θa or more, the rotation speeds of the motors 15 can be limited and the thrust generated by the motors 15 can be reduced. Thus, it is possible to suppress the occurrence of sudden acceleration or excessive speed of the electric wheelchair 1, thereby achieving safe movement.

Step S7 is a step of determining, based on the information from the inertia sensor 8, whether the slope gradient θ of the road surface is less than an upper limit reference angle θc. When the slope gradient θ is less than the upper limit reference angle θc (“Yes” in step S7), the process proceeds to step S9. When the slope gradient θ is equal to or more than the upper limit reference angle θc (“No” in step S7), the process proceeds to step S8.

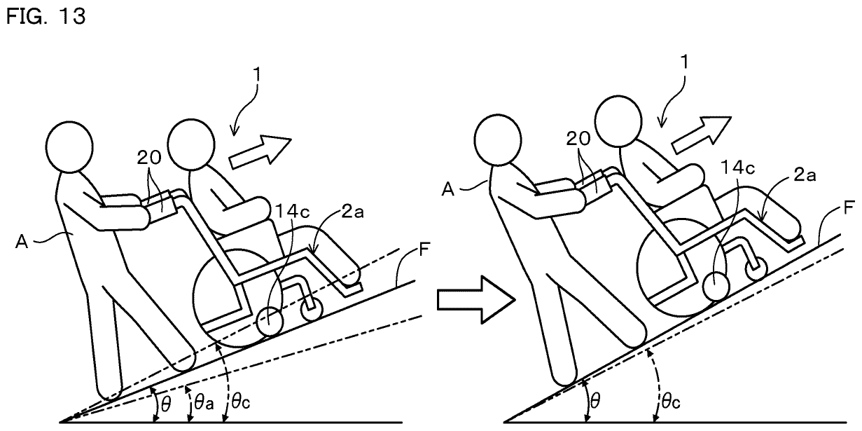

For example, the process proceeds from step S7 to step S9 when the slope gradient θ is between the first reference angle θa and the upper limit reference angle θc (see FIG. 12). For example, the process proceeds from step S7 to step S8 when the slope gradient θ transitions from a value between the first reference angle θa and the upper limit reference angle θc to the upper limit reference angle θc or more (see FIG. 13).

Step S8 is a step of changing, while setting the operation inputs of the grips 20 to 0 (zero), both the feedback coefficient α and the upper limit value of the speed command value for each of the motors 15. In step S8 of the present embodiment, the feedback coefficient α is made larger and the upper limit value of the speed command value for each of the motors 15 is made smaller than those in the case where the slope gradient θ is less than the upper limit reference angle θc. At this time, the value of the feedback coefficient α is larger than the value set in step S6. At this time, the upper limit value of the speed command value is smaller than the value set in step S6. After step S8 is executed, the process proceeds to step S9.

In the case based on step S8, the thrust calculated based on the information detected by the operation detection units 21 and generated by the motors 15 is zero. Therefore, the assistance by the operation on the grips 20 is turned off. Then, the motors 15 operate freely with the speeds limited based on the upper limit value of the speed command value. Thus, safe movement can be achieved as the slope gradient θ transitions to increase up to the upper limit reference angle θc or more.

In steps S6 and S8, description is given of the case where the values of both the control parameters that are the feedback coefficient α and the upper limit value of the speed command value for each of the motors 15 are changed. If necessary, only the value of at least one of the two control parameters may be changed.

### 11. Specific Example of Reference Angle of Slope Gradient

In the present embodiment, the three reference angles (first reference angle θa, second reference angle θb, and upper limit reference angle θc) are defined for the slope gradient. Although the values of the reference angles are not particularly limited, the feedback coefficient α and the upper limit value of the speed command value can be set by setting, for example, the first reference angle θa to 15°, the second reference angle θb to 13°, and the upper limit reference angle θc to 25°.

### 12. Upper Limit Value of Speed Command Value

When the slope gradient is the second reference angle θb or less, the upper limit value of the speed command value can be set to 6 [km/h]. When the slope gradient is the first reference angle θa or more and less than the upper limit reference angle θc, the upper limit value of the speed command value can be set to 3 [km/h]. When the slope gradient is the upper limit reference angle θc or more, the upper limit value of the speed command value can be set to 0.5 [km/h].

### 13. Feedback Coefficient α

When the slope gradient is the first reference angle θa or more and less than the upper limit reference angle θc, the feedback coefficient α can be set to 0.5. When the slope gradient is the upper limit reference angle θc or more, the feedback coefficient α can be set to 5. When the non-holding determination is made or the brake levers 11 are operated for braking, the feedback coefficient α can be set to 0 (zero). When the holding determination is made, the feedback coefficient α can be set to 0.5.

The value of the feedback coefficient α may be changed to increase as the slope gradient increases, and the value of the feedback coefficient α may be changed to increase as the traveling speed of the vehicle body 2a increases. In this case, when the slope gradient is the first reference angle θa or more and less than the upper limit reference angle θc, the feedback coefficient α can be set to 0.5 under the condition that the traveling speed of the vehicle body 2a is equal to or less than the upper limit value of the speed command value (e.g., 3 [km/h]), and the feedback coefficient α can be set to 1 under the condition that the traveling speed of the vehicle body 2a exceeds the upper limit value of the speed command value. When the slope gradient is the upper limit reference angle θc or more, the feedback coefficient α can be set to 5 under the condition that the traveling speed of the vehicle body 2a is equal to or less than the upper limit value of the speed command value (e.g., 0.5 [km/h]), and the feedback coefficient α can be set to 10 under the condition that the traveling speed of the vehicle body 2a exceeds the upper limit value of the speed command value. Thus, the feedback coefficient α can finely be set in response to changes in the slope gradient and changes in the traveling speed of the vehicle body 2a.

### 14. Functions and Effects

Next, the functions and effects of the above embodiment will be described.

In the electric wheelchair 1 of the embodiment, the control device 18 is configured to change the control parameters to be used to control the motors 15 in response to the occurrence of a predetermined change in the operation state of the operator A or a predetermined change in the slope gradient.

With this configuration, safe movement can be achieved by appropriately changing the control parameters of the motors 15 to suppress the occurrence of sudden acceleration or excessive speed of the electric wheelchair 1 in response to the predetermined change in the operation state of the operator A or the predetermined change in the slope gradient.

Therefore, according to the above embodiment, it is possible to provide the electric wheelchair 1 that is excellent in safety when the operation state of an operator changes or the slope gradient changes.

Although the present disclosure has been described based on the above embodiment, it should be understood that the present disclosure is not limited to the embodiment or structure. The present disclosure includes various changes and modifications within the scope of equivalency. In addition, various combinations and forms and other combinations and forms including only one element, two or more elements, or fewer elements are encompassed by the spirit and scope of the present disclosure.

The above embodiment illustrates the case where the feedback coefficient α and the upper limit value of the speed command value are changed among the control parameters of the motors 15. Instead of or in addition to these, any other control parameter may be changed.

The above embodiment illustrates the case where the non-holding determination is made using the operation detection units 21. However, means other than the operation detection units 21 may be used. Examples of the other means include pressure sensors provided on the grips 20. For example, the non-holding state can be determined when the pressures detected by the pressure sensors are below a threshold value, and the holding state can be determined when the pressures are equal to or more than the threshold value.

1. An electric wheelchair comprising:
a vehicle body;
a drive wheel that causes the vehicle body to travel;
a motor that drives the drive wheel;
a grip to be held by an operator and displaceable in a front-rear direction of the vehicle body by an operation of the operator;
an operation detection unit that detects a position of the grip in the front-rear direction; and
a control device that controls the motor based on the position detected by the operation detection unit, wherein the control device changes a control parameter to be used to control the motor in response to occurrence of a predetermined change in an operation state made by the operator or a predetermined change in a slope gradient.

2. The electric wheelchair according to claim 1, wherein the control device
calculates a thrust to be generated by the motor using a spring-damper model including an elasticity term based on a displacement amount of the grip and a viscosity term based on a displacement speed of the grip, and
changes a spring constant of the elasticity term that is the control parameter to gradually increase the spring constant in response to the occurrence of the predetermined change in the operation state made by the operator or the predetermined change in the slope gradient.

3. The electric wheelchair according to claim 2, wherein the predetermined change in the operation state made by the operator is an operation in which the operator switches an operation state of the grip from a non-operating state to an operating state, or an operation in which the operator switches the operation state of the grip from a non-holding state to a holding state.

4. The electric wheelchair according to claim 2, further comprising a brake operation unit to be operated by the operator to mechanically brake the vehicle body, wherein the predetermined change in the operation state made by the operator is an operation in which the operator switches an operation state of the brake operation unit from a brake operation state to a brake operation termination state.

5. The electric wheelchair according to claim 2, wherein the predetermined change in the operation state made by the operator is an operation in which the operator switches an operation state of the grip from a state in which a speed of the vehicle body exceeds a speed limit to a state in which the speed is equal to or less than the speed limit.

6. The electric wheelchair according to claim 2, wherein the predetermined change in the slope gradient is a change in which the slope gradient is switched from a first reference angle or more to less than a second reference angle that is smaller than the first reference angle.

7. The electric wheelchair according to claim 1, wherein the control device
calculates a thrust to be generated by the motor using a spring-damper model including an elasticity term based on a displacement amount of the grip and a viscosity term based on a displacement speed of the grip, and generates a speed command value for the motor based on a value obtained by subtracting an external force in the front-rear direction from the thrust, and
in response to the occurrence of the predetermined change in the slope gradient, changes a feedback coefficient that is the control parameter for calculation of the external force, or changes an upper limit value of the speed command value that is the control parameter.

8. The electric wheelchair according to claim 7, wherein, when the slope gradient transitions to a reference angle or more as the predetermined change in the slope gradient, the control device changes the feedback coefficient to a larger value or changes the upper limit value of the speed command value to a smaller value than in a case where the slope gradient is less than the reference angle.

9. The electric wheelchair according to claim 8, wherein, when the slope gradient transitions to an upper limit reference angle or more, the control device sets the thrust to be calculated based on the position detected by the operation detection unit and to be generated by the motor to zero.

10. The electric wheelchair according to claim 7, wherein the control device changes a value of the feedback coefficient to increase the value of the feedback coefficient as the slope gradient increases, and changes the value of the feedback coefficient to increase the value of the feedback coefficient as a traveling speed of the vehicle body increases.
